(19) United States
(12) Patent Application Publication
(10) Pub. No.: US 2014/0032487 A1
(43) Pub. Date: Jan. 30, 2014

(54) SETTING PRIVILEGES FOR COLLABORATIVE LISTS

(71) Applicants: Todd Rein, San Francisco, CA (US); Eylon Stroh, San Carlos, CA (US); Shashi Rai, Santa Clara, CA (US); Marco Qualizza, Orleans (CA); Roman Dolgov, San Carlos, CA (US); Chris Ethier, Ottawa (CA)

(72) Inventors: Todd Rein, San Francisco, CA (US); Eylon Stroh, San Carlos, CA (US); Shashi Rai, Santa Clara, CA (US); Marco Qualizza, Orleans (CA); Roman Dolgov, San Carlos, CA (US); Chris Ethier, Ottawa (CA)

(21) Appl. No.: 12/129,972

(22) Filed: May 30, 2008

(51) Int. Cl. G06F 17/30

(52) U.S. Cl. 707/608; 707/E17.007; 707/622

(57) ABSTRACT

In one example embodiment, a system and method is shown that includes receiving a collaborative list, the receiving including receiving a share structure that includes one or more members. Further, the system and method includes identifying at least one member of the share structure having access to structured data. Additionally, the system and method includes identifying privilege data associated with the at least one member indicating an access privilege to the collaborative list, the collaborative list including the structured data. Moreover, the system and method includes selectively receiving the structured data based on the access privilege associated with the at least one member. The system and method also includes displaying the structured data in a first display area of the GUI. In addition, the system and method also includes displaying the share structure in a second display area of the GUI.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright© 2008, Adobe Systems Incorporated. All Rights Reserved.

### TECHNICAL FIELD

The present application relates generally to the technical field of algorithms and programming and, in one specific example, Graphical User Interfaces (GUI).

### BACKGROUND

Data may be distributed in the form of a spread sheet or some other form of structured list. The files that include this data may be password protected, or may include other protections that may limit the accessibility of the data included in the file. These protections may include hashing, encryption, or some combination of hashing or encryption, that may be used to obscure or prevent access to the data.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, used to generate a collaborative list and to share a collaborative list across a share structure.

FIG. 2 is a diagram of a share structure, according to an example embodiment, reflecting an organizational hierarchy across which a collaborative list is to be shared.

FIG. 3 is a list display Graphical User Interface (GUI), according to an example embodiment, illustrating a displayed collaborative list.

FIG. 4 is a diagram of a list display GUI, according to an example embodiment, illustrating structure data associated with a node.

FIG. 5 is a diagram of an authoring GUI, according to an example embodiment, used to create structure data and to set the privileges associated with structure data.

FIG. 6 is a diagram of an authoring GUI, according to an example embodiment, that may be used to reset the permissions for an existing collaborative list.

FIG. 7 is a diagram of an authoring GUI, according to an example embodiment, that may be used to distribute or otherwise share a collaborative list.

FIG. 8 is a block diagram of a computer system, according to an example embodiment, used to generate and receive a collaborative list.

FIG. 9A is a method, according to an example embodiment, used to create and distribute a collaborative list.

FIG. 9B is a continuation of a method, according to an example embodiment, used to create and distribute a collaborative list.

FIG. 10 is a tri-stream flow chart illustrating the execution of a method, according to an example embodiment, used to author and distribute a collaborative list.

FIG. 11 is a flow chart illustrating the execution of an operation, according to an example embodiment, to facilitate the setting of privileges for nodes associated with a share structure.

FIG. 12 is a flow chart illustrating the execution of an operation, according to an example embodiment, that may build a portion of a list based upon privileges and a share structure associated with a user.

FIG. 13 is a flow chart illustrating the execution of an operation, according to an example embodiment, that may be executed to transmit a portion of a collaborative list.

FIG. 14 is a flow chart illustrating the execution of an operation, according to an example embodiment, that may build portions of a list using data for which a privilege exists.

FIG. 15 is an example Relational Data Schema (RDS), according to an example embodiment.

FIG. 16 shows a diagrammatic representation of a machine in the example form of a computer system that executes a set of instructions to perform any one or more of the methodologies discussed herein.

### DETAILED DESCRIPTION

In the following description, for purposes of explanation, numerous specific details are set forth in order to provide a thorough understanding of an example embodiment of the present invention. It may be evident, however, to one skilled in the art that the present invention will be practiced without these specific details.

In some example embodiments, a system and method is illustrated that facilitates the sharing of structured data through a share structure. Structured data may include a structure and data included within the structure. A structure may be a collaborative list, a collaborative table, a document or a file having data. Data may be binary, American Standard Code for Information Interchange (ASCII), or Unicode formatted data. This structured data may be displayed in a GUI as a list, a table, a bar graph, pie chart, Gantt chart, calendar, map, or some other suitable manner of presentation. Structured data may include a portion of a collaborative list or collaborative table (e.g., less than all the structured data as a whole or otherwise included in the collaborative list). A share structure may be a data structure representing relations between persons or entities in an organization (e.g., a member or members). Further, these entities may be business units, or other entities in an organization. A person or member may be a natural person or legal entity such as a corporation. For example, an organizational hierarchy, represented graphically as a tree, may reflect a share structure. Sharing may include the distribution of a portion of a collaborative list. In some example embodiments, the structure may be based upon a template defining a list, table or other suitable structure (e.g., referenced as collectively aggregating template data) within which structure data may be displayed.

In some example embodiments, a collaborative list may include structured data, and privilege data defining the privileges associated with each person in a share structure. A list, for example, may be a list of tasks to be performed by persons referenced in a share structure. These persons may be only able to view the tasks that they are assigned to perform, and that persons who report to them (e.g., those under them in an organizational hierarchy) are able to perform. Those not having the privilege to view a particular portion of a collaborative list may not be provided access to this portion of the collaborative list (e.g., an access privilege). In the example case where the portion of the collaborative list includes the result of a mathematical equation or expression, only the data utilized by these mathematical equations or expressions for which one has a viewing privilege may be provided. Privilege data may include a distribute privilege, an edit privilege, a read privilege, or some other suitable privilege associated with a person in the share structure. These privileges may be assigned without or without additional limitation to other persons in the hierarchy, but may not be expanded upon. Put another way, a person cannot grant privileges that they do not have to other persons.

In some example embodiments, a portion of this share list may be accessed (e.g., distributed) on an as requested basis using a network configured in a client-server architecture. A user in the form of a person that is part of the share structure may request to view a portion of a collectively list. The viewing of this collaborative list may be facilitated through the use of a GUI in the example form of a browser application in combination with a client engine. A browser application may include some type of Hyper Text Markup Language (HTML) or eXtensible Markup Language (XML) interpreter. A client engine may be a FLASH® engine, JavaScript engine, Java Engine, or ACTIVE X™ engine. For example, using the JavaScript engine, Asynchronous JavaScript and XML (AJAX) technologies may be utilized to retrieve portions of the collectively list on an as needed basis. The portion of the collaborative list may be retrieved from a computer system in the form of a collaborative list server. A client computer system using the above outlined browser and client engine may communicate over a network with the collaborative list server using a Hyper Text Transfer Protocol (HTTP). This communication may be via a logical or physical link between the collaborative list server and the client computer system.

In some example embodiments, a plurality of different screen objects and widget may be utilized by the GUIs illustrated herein. A screen object or widget may be an element of a GUI that displays an information arrangement changeable by the user, such as a window or a text box. These elements may further include graphical pointer (e.g., a mouse pointer), tooltip, popup frame, scroll bar, drop down menu, button, radio button, or other suitable screen object or widget.

### Example System

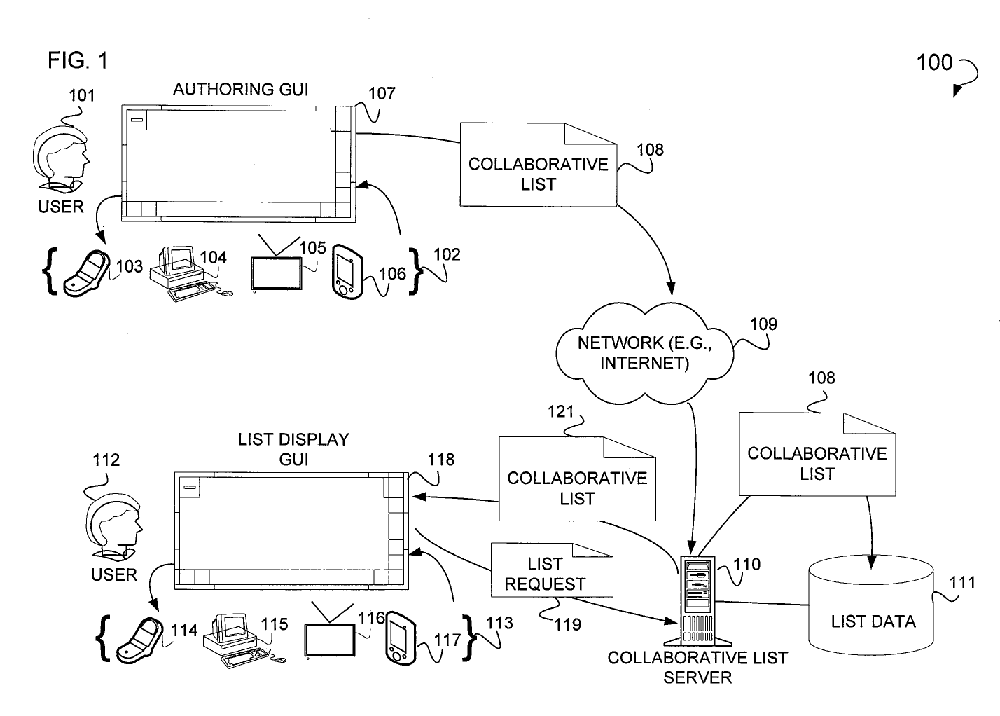

FIG. 1 is a diagram of example system 100 used to generate a collaborative list and to share a collaborative list across a share structure. Shown is a user 101, who, utilizing an authoring GUI 107, may generate a collaborative list 108. This authoring GUI 107 may be generated by the one or more devices 102. These one or more devices 102 may include a cell phone 103, a computer system 104, a television 105, a Personal Digital Assistant (PDA) 106, or a smart phone (not shown). These one or more devices 102 may transmit a collaborative list 108 across a network 109 to be received by a collaborative list server 110. This collaborative list 108 may contain structure data in the form of a list, a share structure associated with this structure data, and various privileges associated with members of the share structure. For example, the share structure may represent the organizational structure of a business, or, more specifically, the organizational hierarchy created for the employees who may be associated with a business. The collaborative list server 110 may take the collaborative list 108 and store it into a list data database 111 for future retrieval. In some example embodiments, the user 101 may be an author of the collaborative list 108.

In some example embodiments, a user 112 utilizing a list display GUI 118 may generate a list request 119. Responsive to the list request 119, a collaborative list 121 may be returned and displayed for the user 112 and a list display GUI 118. The list display GUI 118 may be generated through the use of one or more devices 113. These one or more devices 113 may include a cell phone 114, a computer system 115, television 116, a PDA 117, or a smart phone (not shown). Using these one or more devices 113, in combination with a list display GUI 118, a list request 119 is generated and transmitted across a network (not shown) to be received by the collaborative list server 110. The collaborative list server 110 may retrieve the collaborative list 121 from the list data database 111. This collaborative list 121 is transmitted by the collaborative list server 110 across a network (not shown) to be received by the one or more devices 113. This collaborative list 121 may then be displayed within the list display GUI 118. The network connecting the one or more devices 113 in the collaborative list server 110 may be the network 109, or some other suitable network. In some cases, the list request 119 may include unique identifying information to uniquely identify a particular collaborative list. The unique identifying information may be in the form of an integer value, or a string value. Further, in some example embodiments, the authoring GUI 107 and the list display GUI 118, and the functionality associated therewith, may be part of the same GUI.

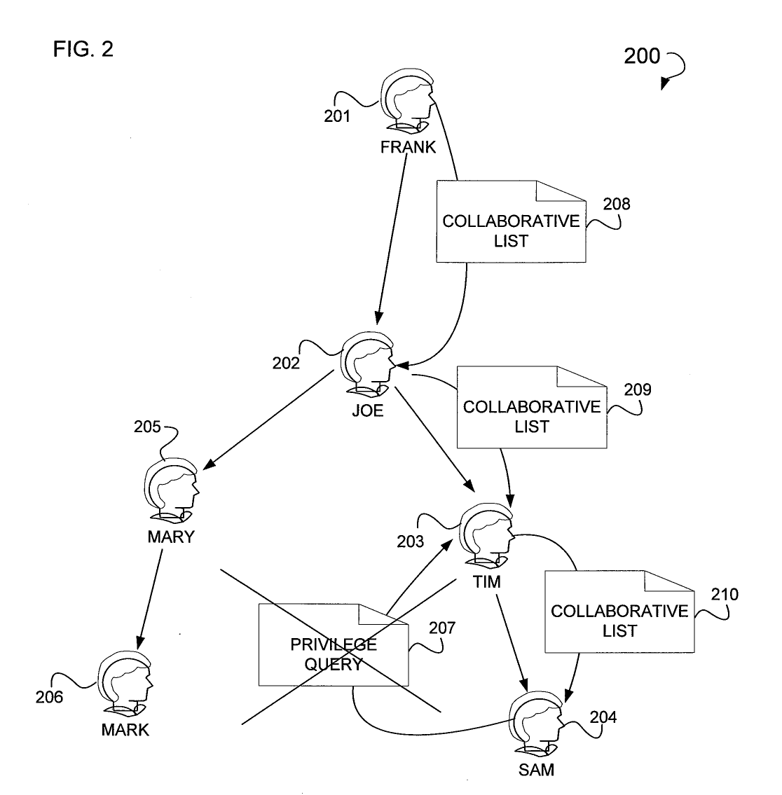

FIG. 2 is a diagram of an example share structure 200 reflecting an organizational structure (e.g. a hierarchy) across which a collaborative list is to be shared. In some example embodiments, the nodes referenced below may correspond to persons in a businesses' organizational structure. Further, these nodes may be members of a share structure. Shown is a node 201 titled “Frank.” In some example embodiments, the node 201 is a root node in a tree structure. Also shown is a node 202 titled “Joe.” The node 202 is an internal node or child node. In some cases, a collaborative list 208 may be passed from the node 201 to the node 202. Also shown is a node 205 titled “Mary” and a node 203 titled “Tim.” These nodes 205 and 203 may thought of as internal or child nodes. A collaborative list 209 is passed from the node 202 to the node 203. This collaborative list 209 is distinct from the collaborative list 208 in that it may contain fewer privileges associated with the structured data and/or less data relative to the collaborative list 208. Further, shown is a node 206 titled “Mark” and a node 204 titled “Sam.” These nodes may be leaf nodes. A collaborative list 210 may be passed from the node 203 to the node 204. This collaborative list 210 may include fewer data and privileges relative to the collaborative list 209. In some example cases, the node 204 may make queries as to the data included in the collaborative list 209, and the privileges associated with this list (represented here as 207). In some example embodiments, this share structure 200 would prohibit such a query.

In some example embodiments, the share structure 200 may be implemented as a number of objects having attributes and methods associated with each. For example, a node as illustrated above is an object. Further, each of these objects may reflect a person or class of persons. Additionally, each of these objects may be organized into a hierarchical data structure such as a tree, list, or other suitable data structure. This tree may reflect the organizational structure of a business.

### Example Interfaces

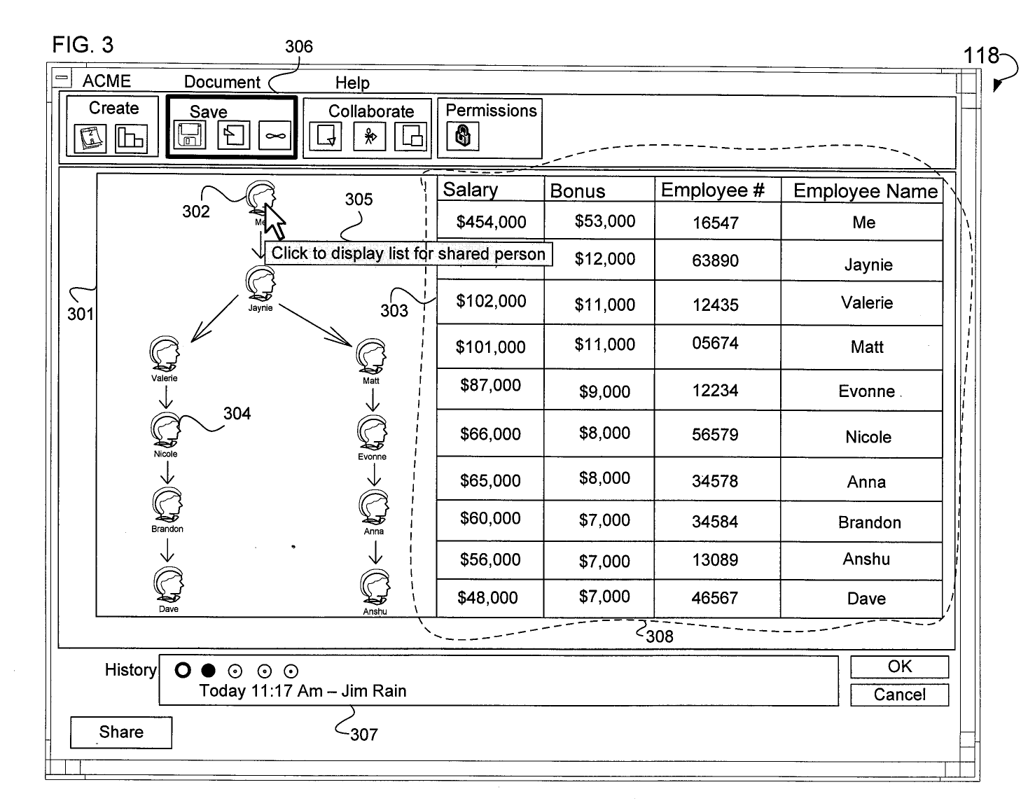

FIG. 3 is an example list display GUI 118 illustrating a displayed collaborative list. Shown is a display area (e.g., a sub frame) 301 of the GUI 118 displaying a share structure including a root node 302 titled “Me.” Also shown is a structure 303 in the form of a list illustrating various employees' names, numbers, salaries, and bonuses. Included in this structure 303 is data 308 (collectively referenced as structured data). A node 304 is shown titled “Nicole.” Additionally, a button 306 is shown titled “Save.” Through executing a save function invoked by the user's selection of the button 306, a collaborative list 108 is saved as a file, linked to via a web link, or otherwise accessed. Additionally, the structure 303 that is part of this collaborative list 108 may also be saved. Also shown is a field 307 containing various radio buttons relating to versioning histories. In some example embodiments, one of these radio buttons is executed to show a previous version of the structure 303 and/or of the share structure displayed in sub frame 301. Further, a pointer and tooltip 305 is illustrated. The pointer and tooltip 305 may be controlled by an input device that may include a mouse, keyboard, light pen, touch screen, pointing device, or other suitable input device. Using this pointer and tooltip 305, the structure 303 for a particular node in the share structure is illustrated. The data 308 displayed in the structure 303 may vary based upon which node is selected using the pointer and tooltip 305. Here, for example, the root node 302 may have access to all data in the structured data associated with all other nodes residing under the root node 302 in a share structure. The share structure shown in sub frame 301 is the example share structure 200.

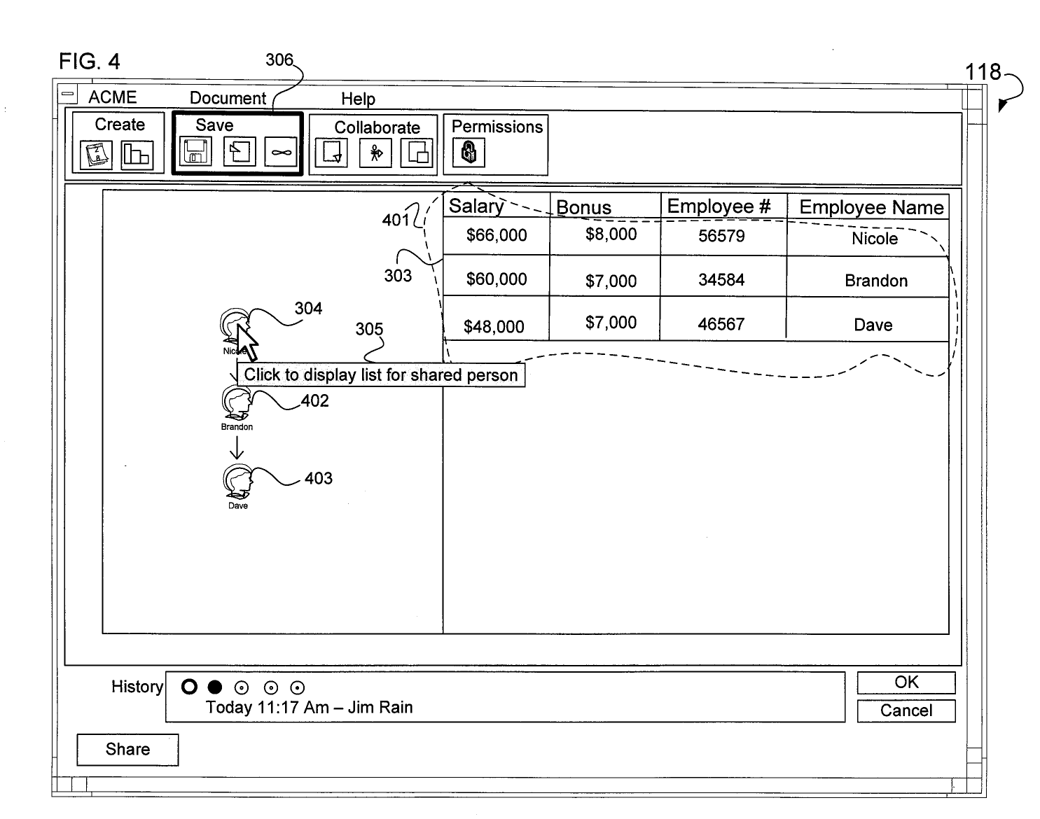

FIG. 4 is a diagram of an example list display GUI 118 illustrating structure data associated with a node. In some example embodiments, the pointer and tooltip 305 is used to select the node 304. Associated with this node 304 is data 401 that represents a reduced amount of data relative to, for example, the data 308. Additionally, in contrast to FIG. 3 the data 308 has not been provided to and displayed within the example list display GUI 118, because the node 304 does not have the privilege to view data 308. Rather, the node 304 only has the privilege to view a reduced version of data 308 in the form of data 401. The data 401 reflects data not only for the node 304, but also for a node 402 titled “Brandon,” and a node 403 titled “Dave.” Additionally, in some example embodiments, the share structure displayed in sub frame 301 is truncated to only display nodes entitled to review the data 401 displayed as part of the structure 303. For example, it may be the case that only nodes 304, 402, and 403 may be displayed in sub frame 301.

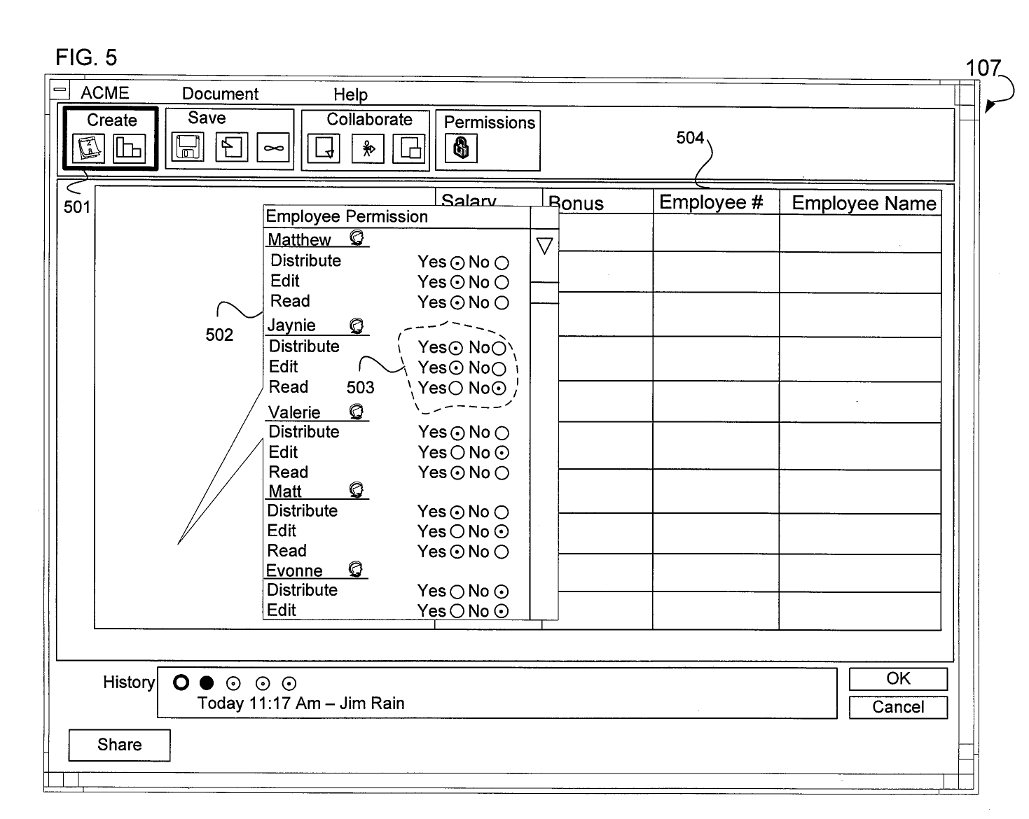

FIG. 5 is a diagram of an example authoring GUI 107 used to create structure data and to set the privileges associated with structure data. In some example embodiments, the user 101 may execute a create button 501. For example, using the create button 501, structured data (e.g., a list) is generated and stored. When the create button 501 is executed, a popup frame 502 is generated to show potential members of a share structure such as the share structure 200, or the example share structure illustrated in sub frame 301. The privileges associated with the share structure may also be shown. These privileges may be represented in a field 503 wherein radio buttons is executed to select these various privileges. The privileges may include a distribute privilege (e.g., a share privilege), an edit privilege, or read privilege. In some example embodiments, a privilege exists to edit a structure such that, for example, a structure may be changed from a list to a table. Further, in some example cases, a privilege may exist to edit data include within the structure. Collectively applied, the privilege to edit a structure and a privilege to edit data may result in privilege to edit structured data. Other suitable privileges may also be selected and displayed. Further, the structure data associated with the share structure may be represented in the form of a table 504, or some other suitable structure.

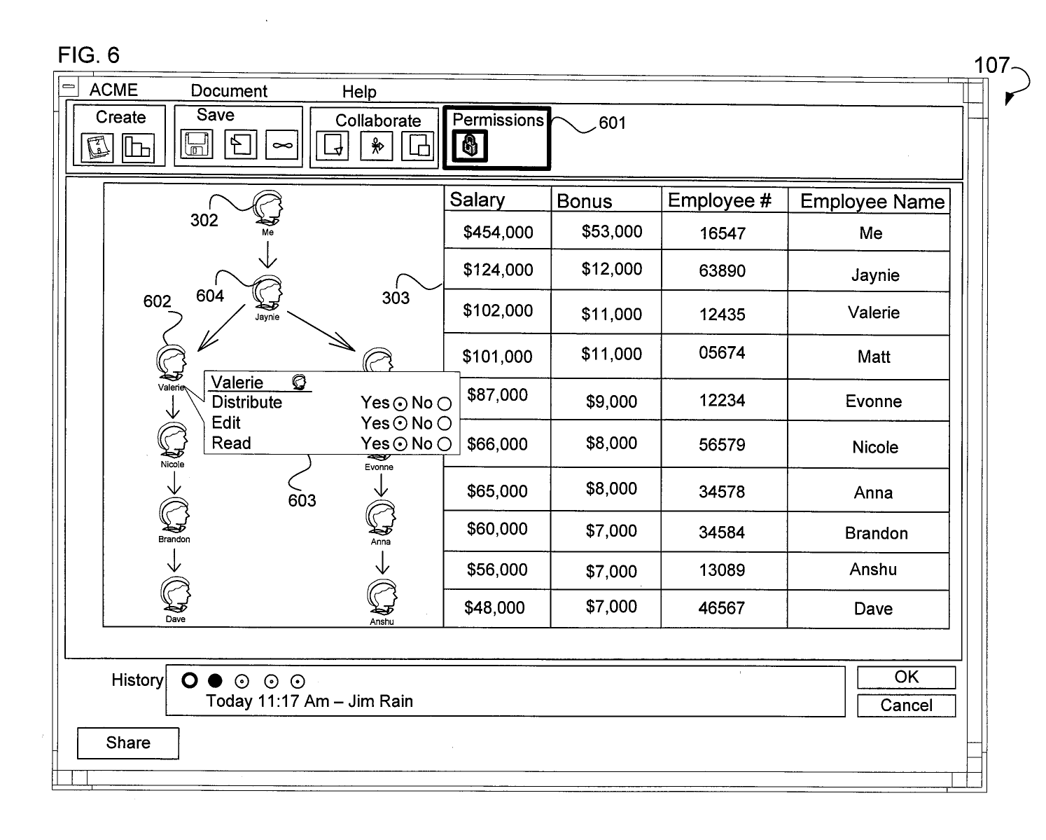

FIG. 6 is a diagram of an example authoring GUI 107 that may be used to reset the permissions for an existing collaborative list. Shown is a button 601 that when executed may create a popup frame 603 associated with, for example, a node 602 titled “Valerie.” Displayed within this popup frame 603 are number of radio buttons that may be used to edit or change privileges associated with the node 602. These privileges include, for example, a distribute privilege (e.g. a share privilege), an edit privilege, a read privilege, or some other suitable privilege. In some example embodiments, the resetting of privileges may only be executed by nodes that are higher in a particular share structure. As illustrated, these nodes may be the root node 302 or the node 604.

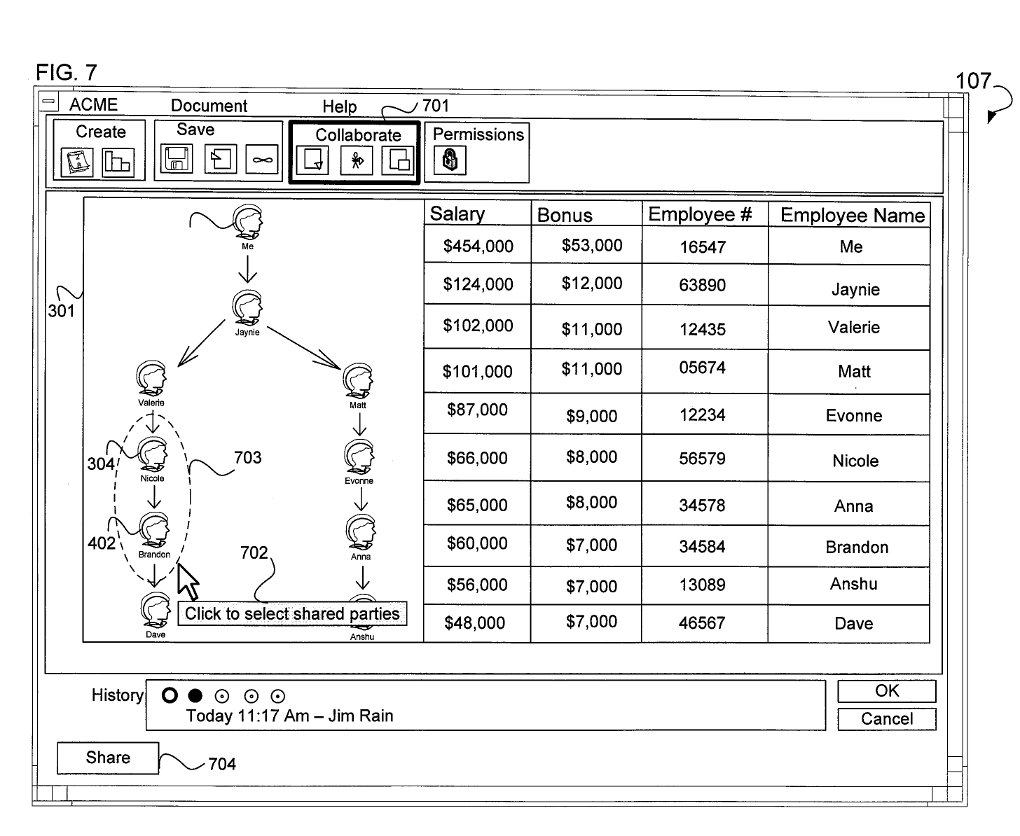

FIG. 7 is a diagram of an example authoring GUI 107 that may be used to distribute or otherwise share a collaborative list such as collaborative list 121. Shown is a button 701 that, when selected, may invoke display of a share structure within the previously illustrated sub frame 301. Using, for example, a pointer and tooltip 702, one or more nodes in this share structure may be selected as referenced herein at 703. Once selected, a button 704 titled “Share” is executed by, for example, the user 101 that may then transmit the collaborative list 121 to certain nodes. These nodes may include node 304 and node 402 as selected at 703.

In some example embodiments, the various GUIs illustrated above in FIGS. 3-7 may be configured to reflect the needs of a particular user such as user 101 or user 112. In one example embodiment, the user 101 or 112 may configure (e.g., generate configuration settings) the sub frames, and screen objects or widgets to meet their individuals needs. These configuration settings may be stored to the one or more devices 102 or 113. For example, a sub frame may resized, a screen object or widget repositioned or some other suitable configuration may occur.

### Example Logic

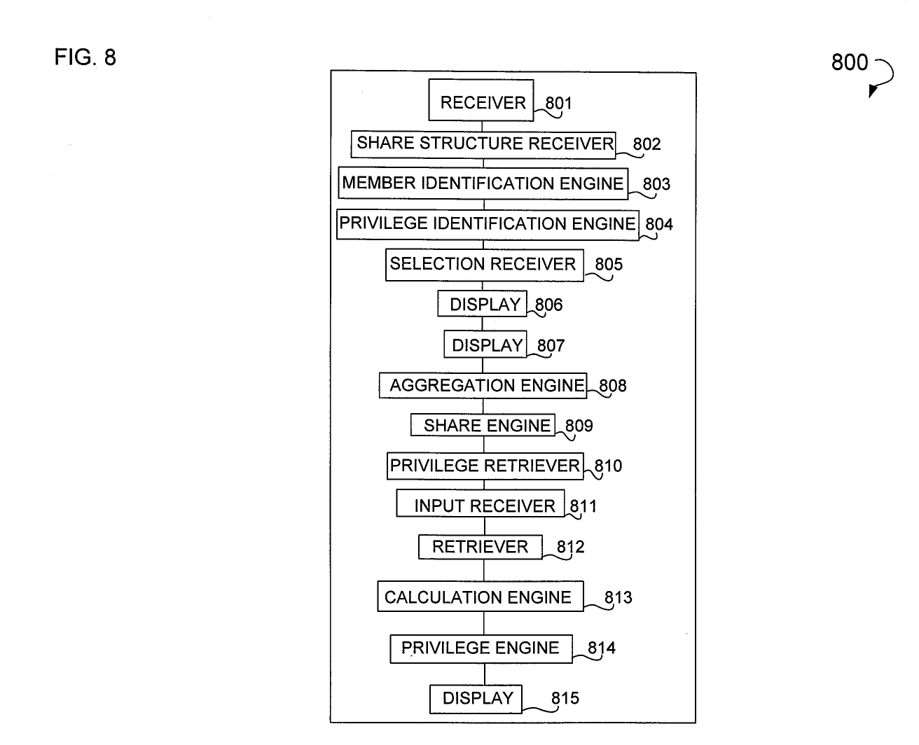

FIG. 8 is a block diagram of an example computer system 800 used to generate and receive a collaborative list. The blocks illustrated herein may be implemented in hardware, firmware, or software. These blocks may be implemented by the one or more devices 102, 113, or collaborative list server 110. Further, these blocks are communicatively coupled via a logical or physical connection. Illustrated is a computer system including a receiver 801 to receive a collaborative list. This receiver 801 may include addition blocks 802 through 805 to which the receiver 801 is communicatively coupled. A share structure receiver 802 is shown to receive a share structure that includes one or more members. Communicatively coupled to this share structure receiver 802 is a member identification engine 803 to identify at least one member of the share structure having access to structured data. Moreover, a privilege identification engine 804 is communicatively coupled to the member identification engine 803 to identify privilege data associated with the at least one member indicating an access privilege to the collaborative list, the collaborative list including the structured data. Further, a selection receiver 805 is communicatively coupled to the privilege identification engine 804 to selectively receive the structured data based on the access privilege associated with the at least one member. A display 806 is communicatively coupled to the receiver 801 to display the structured data in a first display area of the GUI. Further, an additional display 807 is communicatively coupled to the receiver 801 to display the share structure in a second display area of the GUI.

In some example embodiments, the computer system 800 includes an aggregation engine 808 that is communicatively coupled to the receiver 801 to aggregate template data from a plurality of source templates to generate a template. The structured data may be displayed using the template. In some example embodiments, the privilege identification engine 804 is implemented to identify an additional member, and additional privilege data associated with the additional member. Communicatively coupled to the privilege identification engine 804 is a share engine 809 to determine that, based upon the additional privilege data, the additional member is to be denied access to the collaborative list. In some example embodiments, the selection receiver 805 is implemented to selectively receive a portion of the collaborative list based on the determination, the portion of the collaborative list including a reduced amount of the structured data relative to the structured data as a whole. The display 806 may be communicatively coupled to the selection receiver 805 and used to display the reduced amount of the structured data in the first display area of the GUI. In some example embodiments, the structured data is structured as at least one of a list or a table. Further, in some example embodiments, the share structure is a tree. Additionally, the tree may reflect the organization of a legal entity.

In some example embodiments, the computer system 800 includes a privilege retriever 810 to retrieve at least one privilege associated with an additional member of the share structure. Communicatively coupled to this privilege retriever 810 is an input receiver 811 to receive selection input, through the input device, to set the at least one privilege associated with the additional member of the share structure. In some example embodiments, this input receiver 811 receives selection input through the input device identifying an additional member of the share structure to access the collaborative list. Communicatively coupled to this input receiver 811 is an enablement engine to enable access by the additional member to the collaborative list based, in part, upon the existence of an additional access privilege associated with the additional member of the share structure. The access privilege may includes at least one of a distribute privilege, an edit privilege, or a read privilege. Further, in some example embodiments, the input receiver 811 receives selection input identifying the at least one member of the share structure, the identifying including the use of a graphical pointer.

In some example embodiments, the computer system 800 includes a retriever 812 to retrieve list data for an equation, the equation including a mathematical expression. This retriever 812 is communicatively coupled to the receiver 811. Communicatively coupled to the retriever 812 is a calculation engine 813 to compute the equation using the list data to build a list, the list including a result of the computing of the equation. Communicatively coupled to the retriever 812 is a privilege engine 814 to remove a portion of the list for which a privilege does not exist to view the portion, the privilege including a user privilege. In some example embodiments, the portion of the list includes data stored in at least one of a row, a field, or a column. Communicatively coupled to the privilege engine 814 is a display 815 to display the collaborative list in a GUI. This display 815 may be the same as the display 806 and 807, or a distinct display.

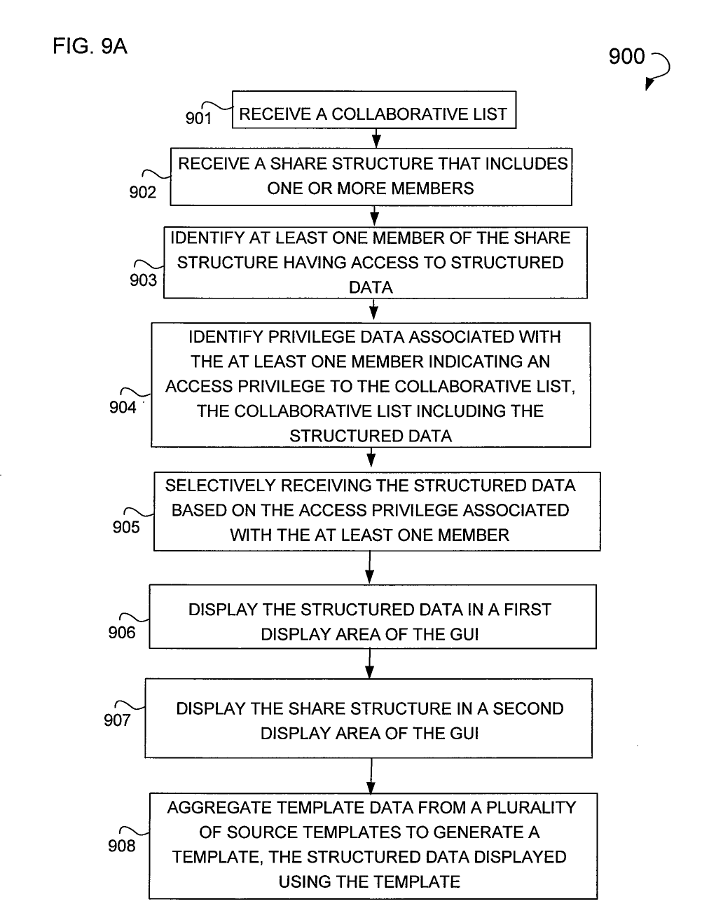

FIG. 9A is an example method 900 to create and distribute a collaborative list. The various operations outlined below may be implemented by one or more devices 102, 113, or the collaborative list server 110. A GUI and input device may be used in conjunction with this method 900. Shown is an operation 901 that, when executed, receives a collaborative list. This operation 901, when executed, may further include operations 902 through 905. An operation 902 when executed, receives a share structure that includes one or more members. An operation 903, when executed, identifies at least one member of the share structure having access to structured data. An operation 904, when executed, identifies privilege data associated with the at least one member indicating an access privilege to the collaborative list, the collaborative list including the structured data. Further, an operation 905, when executed, selectively receiving the structured data based on the access privilege associated with the at least one member. Additionally, an operation 906, when executed, displays the structured data in a first display area of the GUI. Moreover, an operation 907, when executed, displays the share structure in a second display area of the GUI. An operation 908 is shown that, when executed, aggregates template data from a plurality of source templates to generate a template, the structured data displayed using the template. In some example embodiments, template data includes data defining the structure of the data displayed as part of the share structure. For example, template data may not only define a table, but additional template data from another template may define the column headings within the table.

FIG. 9B is a continuation of the method 900 used to create and distribute a collaborative list. In some example embodiments, an operation 909 is illustrated that, when executed, identifies an additional member, and additional privilege data associated with the additional member. An operation 910 is illustrated that, when executed, determines that, based upon the additional privilege data, the additional member is to be denied access to the collaborative list. An operation 911 is illustrated that, when executed, selectively receives a portion of the collaborative list based on the determination, the portion of the collaborative list including a reduced amount of the structured data relative to the structured data as a whole. Operation 912 is shown that, when executed, displays the reduced amount of the structured data in the first display area of the GUI. The structured data may be structured as at least one of a list or a table. The share structure may be a tree. Additionally, the tree may reflect the organization of a legal entity. An operation 913 is shown that, when executed, retrieves at least one privilege associated with an additional member of the share structure. Operation 914 is shown that, when executed, receives selection input, through the input device, to set the at least one privilege associated with the additional member of the share structure. Further, operation 915 is shown that, when executed, receives selection input through the input device identifying an additional member of the share structure to access the collaborative list. Operation 916 is illustrated, that when executed, enables access by the additional member to the collaborative list based, in part, upon the existence of an additional access privilege associated with the additional member of the share structure. The access privilege may include at least one of a distribute privilege, an edit privilege, or a read privilege. An operation 917 is shown that, when executed, receives selection input identifying the at least one member of the share structure, the identifying including the use of a graphical pointer.

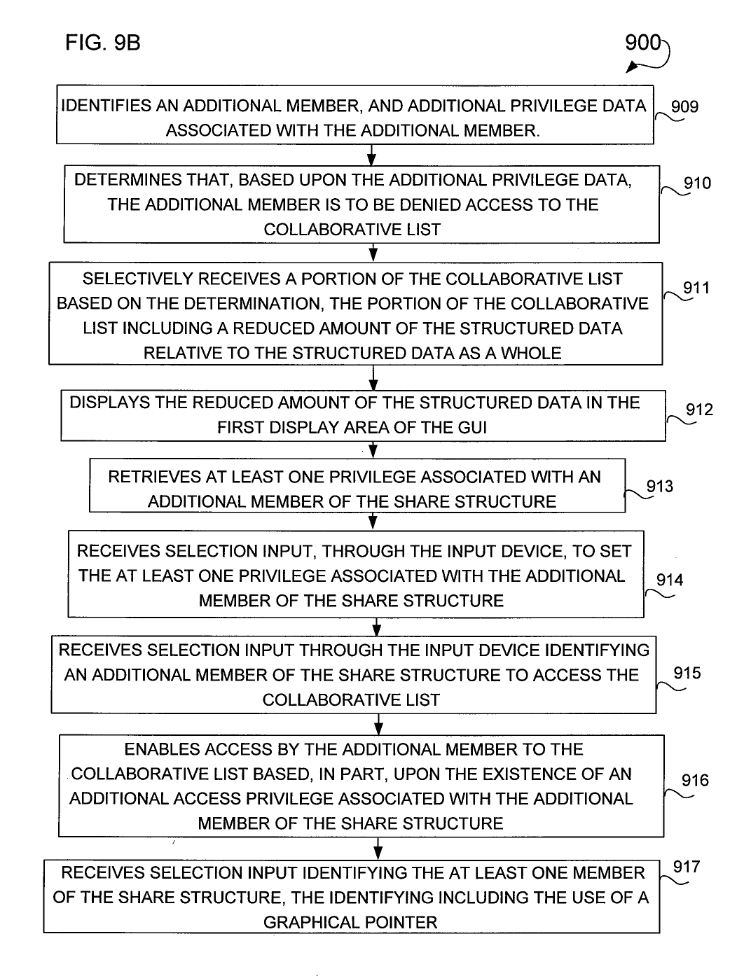

FIG. 10 is a tri-stream flow chart illustrating the execution of an example method 1000 used to author a collaborative list 108, and to distribute this collaborative list 108 as, for example, a collaborative list 121. Shown are operations 1001 through 1002, and 1005 through 1008 that may be executed by the one or more devices 102. Also shown are operations 1003 through 1004, and 1009 through 1013 that is executed by the collaborative list server 110. Further, shown are operations 1014 and 1015 that may be executed by the one or more devices 113.

In some example embodiments, an operation 1001 may be executed that may receive input from some type of input device such as a pointing device (e.g., a mouse), light pen, keyboard, or other type of input device. An operation 1002 is executed to transmit a list template request, and a share structure request across the network 109 to be received by the execution of an operation 1003. A list template request may also request a table template or some other suitable basis for structuring data. An operation 1004 is executed to retrieve and transmit a list template and share structure from, for example, the list data database 111. One or more Structured Query Language (SQL) based commands is used to retrieve the list template and share structure. An operation 1005 is executed to receive this list template and associated share structure. An operation 1006 is executed to facilitate the setting of privileges for those nodes that are associated with the share structure. Setting may include the receiving of selection input selecting one or more privileges. In some example cases, an operation 1007 is executed to receive data 1020 for a list template. This data 1020 may be displayed in structure 303. An operation 1008 is executed to then transmit this collaborative list as, for example, a collaborative list 108 to be received through the execution of operation 1009. An operation 1010 is executed to then store this collaborative list into the previously illustrated list data database 111. A SQL command may be used to store this collaborative list into the list data database 111.

In some example embodiments, an operation 1014 is executed to generate and transmit a list portion request to receive through the execution of operation 1011. A list portion request may be a request for the data 401 as displayed in the structure 303. This portion may be based upon certain privileges associated with a person such as depicted by node 304. An operation 1012 is executed to build a portion of a list based upon privileges and a share structure associated with the user 112. An operation 1013 is executed to transmit a portion of a collaborative list in the form of, for example, the collaborative list 121 to be received through the execution of operation 1015. A display 1016 is executed to display the collaborative list 121 to, for example, the user 112 utilizing the list display GUI 118. As illustrated above, this list display GUI 118 is generated by the one or more devices 113.

In some example embodiments, a template request may be a request for a list template. A list template may be, for example, some type of predefined data structure for structure data, wherein the data structure is a list, table, or some other suitable data structure. Privileges may include, for example, the previously illustrated distribute or share privilege, an edit privilege, a read privilege, or some other suitable privilege. A portion of a list (e.g., portions of data) may include data that is reduced relative to another example of data, for example, the structured data that is part of the collaborative list 121 as compared to the collaborative list 108.

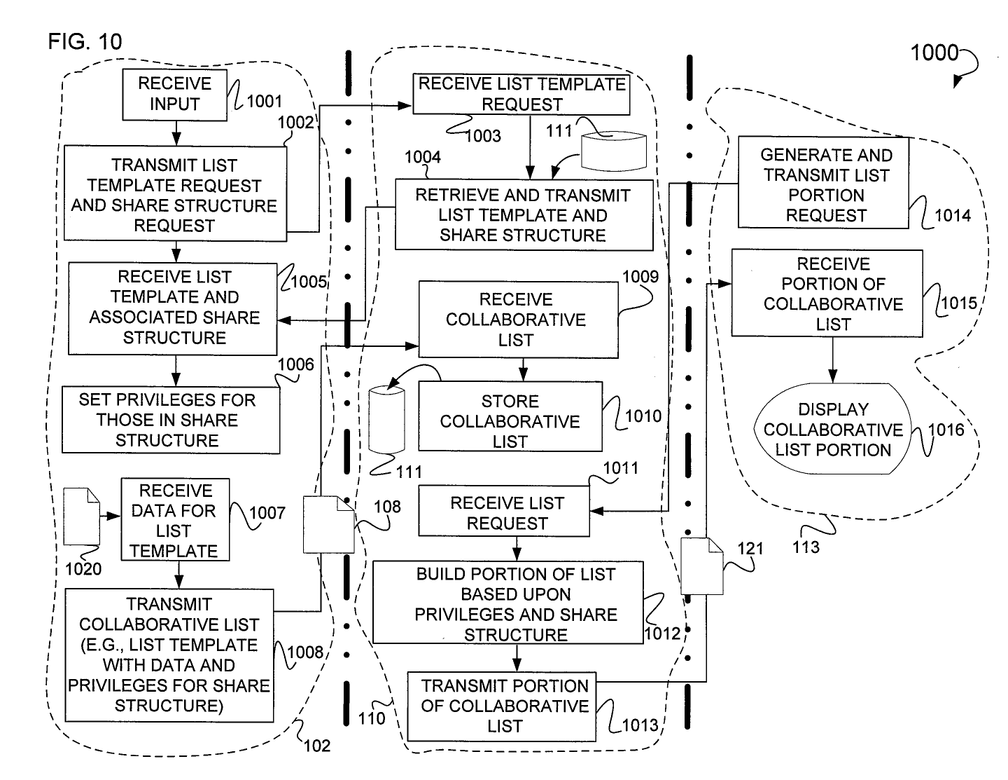

FIG. 11 is a flow chart illustrating the execution of operation 1006. Shown is an operation 1101 that when executed they may receive a share structure. The share structure may be displayed via the display 1102. FIG. 3 may illustrate, for example, the display 1102. In some example cases, a privilege selection 1103 is received through the execution of operation 1104. This privilege selection 1103 may relate to, for example, a node of a share structure, and may include the privileges associated with this node. The privilege selection 1103 may include input selecting privileges to be associated with an object representing a node in a share structure. The node, as illustrated above, is an object and the privilege an attribute of this object. A decisional operation 1105 is executed to determine whether there are additional privileges to be received or selected for additional nodes. In cases where decisional operation 1105 evaluates to “true,” the operation 1104 is re-executed. In cases where decisional operation 1105 evaluates to “false,” an operation 1106 is executed to associate a privilege selection with a particular node of a share structure.

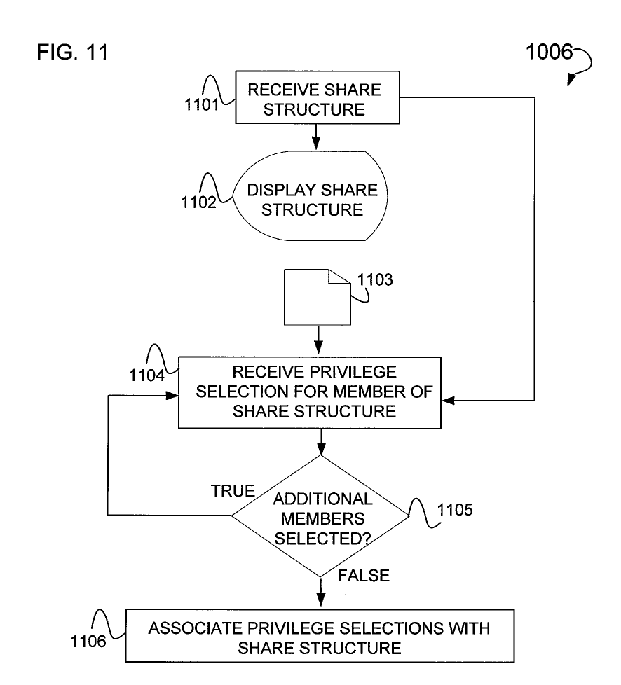

FIG. 12 is a flow chart illustrating the example execution of operation 1012. Shown is an operation 1201 that receives a list request. An operation 1202 is executed to retrieve privileges associated with this list request. A decisional operation 1203 is executed to determine whether or not there are expressions included within the requested list. Expressions may be mathematical, logical, or other expressions utilizing one or more binary or unary operators. In cases where decisional operation 1203 evaluates to “false,” an operation 1205 is executed to retrieve list data from for example the previously illustrated list data database 111. An operation 1210 may then be executed to build portions of the list using data for which a privilege exists. This privilege may be the distribute privilege or read privilege. In some example cases, only data will be provided for the building of a share structure for which a privilege exist. In example cases where decisional operation 1203 evaluates to “true,” an operation 1204 is executed to retrieve list data of for a particular expression. The list data may be retrieved from the previously shown list data database 111. An operation 1206 is executed to compute equations for a list using the expression and retrieved list data. An operation 1207 is executed to build portions of the list that used the equation. An operation 1208 is executed to build remaining portions of a list using data for which a privilege exists. An operation 1209 is executed to remove portions of a list, such as fields, columns, or rows relating to the equation for which a privilege exists. In some example embodiments, certain members (e.g., nodes) of the share structure may not be privileged to have the portions of the list and data included therein, displayed. This data may be used to compute certain equations. For example, node 304 may not be entitled to review the data that is used to compute certain equations used to determine bonuses for, for example, the root node 302. Given that the privilege does not exist for the node 304, the data used to compute the bonuses for root node 302 may be removed from the provided structure data prior to generating the collaborative list 108, or the collaborative list 121. An operation 1211 is executed to associate the privileges with the list to create a collaborative list, where the collaborative list may be the previously illustrated collaborative list 108, or the previously illustrated collaborative list 121.

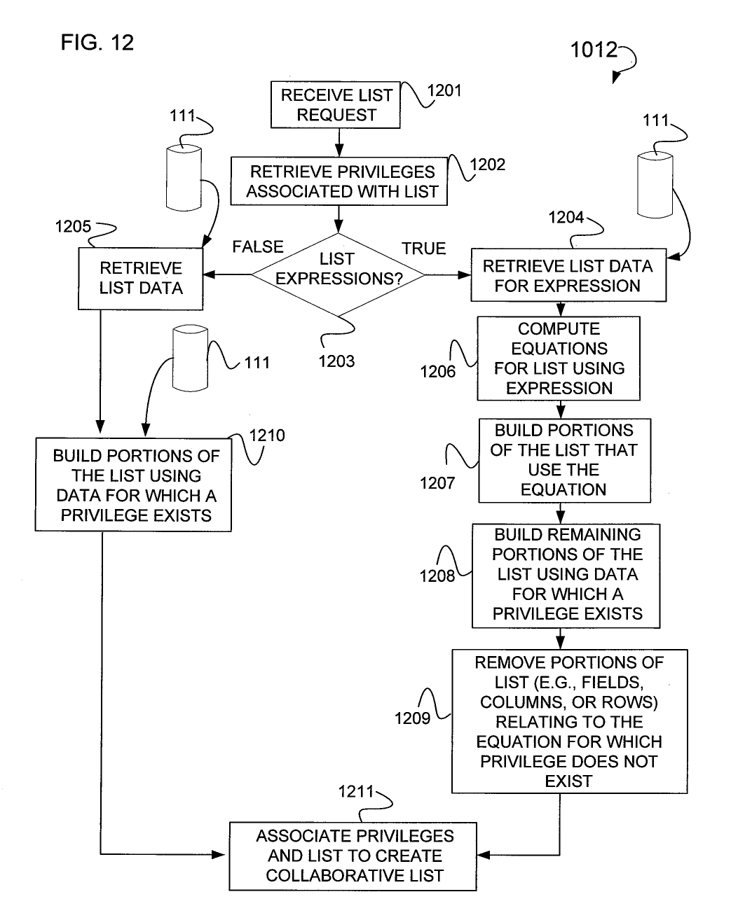

FIG. 13 is a flow chart illustrating an example execution of operation 1013. Shown is an operation 1301 to retrieve a collaborative list. An operation 1302 is executed to transmit portions of this collaborative list as a request is received. In some example embodiments, rather than transmitting the collaborative list 121 as a complete file, only portions of the structured data included within this collaborative list 121 is transmitted. These transmissions may be done asynchronously. A decisional operation 1303 is executed to determine whether a request has been made for an additional portion of the structured data. In cases where decisional operation 1303 evaluates to “false,” a termination condition 1304 is executed. In cases where decisional operation 1303 evaluates to “true,” an operation 1305 is executed to transmit an additional request for a portion of a structured data. Upon the completion of operation 1305, the decisional operation 1303 is re-executed.

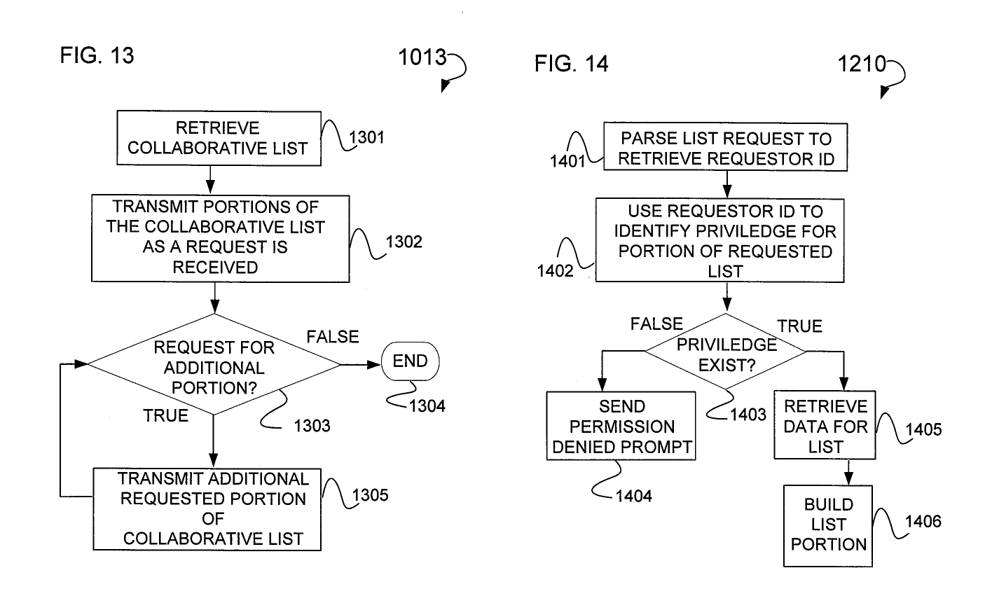

FIG. 14 is a flow chart illustrating an example execution of operation 1210. Shown is an operation 1401 that, when executed, may parse a list request to retrieve a requester ID. A requester ID may be associated with a user 112 or other person entitled to review data (e.g., data 308, or data 401) for the collaborative list 121 or 108. An operation 1402 is executed to use a requestor ID to identify privileges associated with the requesting party requesting a portion of, or all of, a requested collaborative list. A decisional operation 1403 is executed to determine whether a privilege exists or is associated with the particular requestor ID. In example cases where decisional operation 1403 evaluates to “false,” an operation 1404 is executed to send a permission denied prompt to the requester (e.g., user 112). In example cases where decisional operation 1403 evaluates to “true,” an operation 1405 is executed to retrieve structured data, and the data included therein, for a collaborative list. Further, an operation 1406 is executed to build a list portion where this list portion may correspond to, for example, the data 401.

### Example Database

Some embodiments may include the various databases (e.g., list data database 111) being relational databases, flat files, or, in some cases, On Line Analytic Processing (OLAP)-based databases. In the case of relational databases, various tables of data are created and data is inserted into and/or selected from these tables using SQL, or some other database-query language known in the art. In the case of OLAP databases, one or more multi-dimensional cubes or hyper cubes, containing multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 81™, 10G™, or some other suitable database application may be used to manage the data. In the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

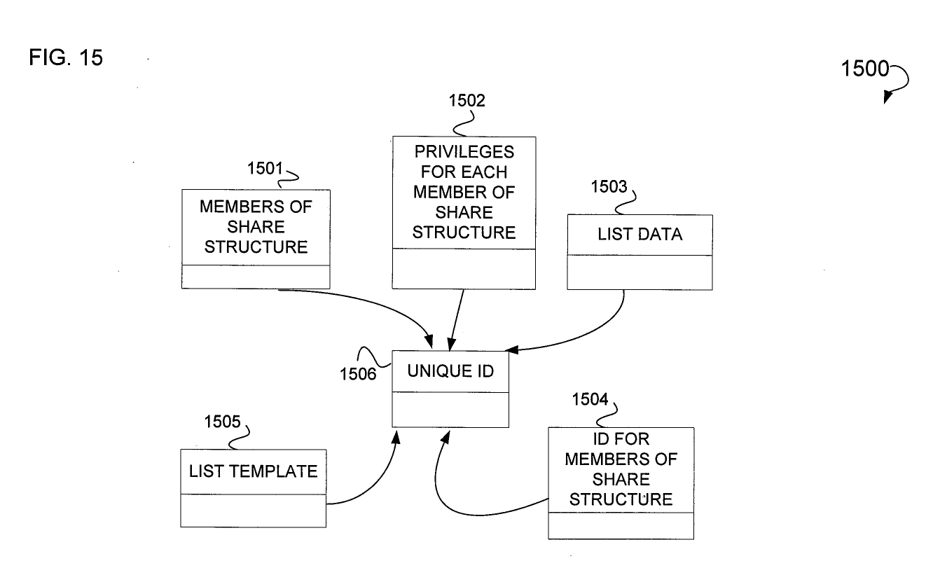

FIG. 15 is an example Relational Data Schema (RDS) 1500. Shown is a table 1501 containing data relating to members of a share structure. The data included within table 1501 may include requester IDs corresponding to members of a share of structure where these members of the share structure may be the nodes 304, 402, 403 or 302. An integer or other suitable data type may be used to store data within the table 1501. Table 1501 may contain various objects having associated methods and attributes. These objects may correspond to nodes included within a particular share structure, and may further correspond to the node 302, 304, 402 or 403. Further, shown is a table 1502 that may include the privileges associated with each member of the share structure. These privileges may be the previously illustrated distribute, edit, read, or other suitable privilege. These privileges may be stored via a Boolean data type, an integer data type, or some other suitable data type. Further, shown is a table 1503 including list data. This list data may be the data 308, 401, 1020, and may be stored as an XML data type, or some other suitable data type. Additionally, shown is a table 1504 including the ID for members of the share data structure. These IDs may be IDs that may be used to identify members of the share data structure such as the nodes 302, 304, 402, 403 stored and identified via an integer data type. A table 1505 is shown that includes a list template or other templates that may be used to provide a structure (e.g., a template) for data 308 or data 401. This template may include a template in lieu of a list template. Further, a template may include column captions such as “salary”, “bonus”, “employee #”, “employee name”, or other suitable column that may instruct an example user 101 or user 112 as to how to input or view the data 308 or 401. A table 1506 is shown that may include a unique identifier or key value to uniquely identify the data stored in each of the tables 1501 through 1505.

### Component Design

Some example embodiments may include the above-illustrated operations being written as one or more software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various Application Programming Interfaces (APIs) and then compiled into one complete server and/or client application. The method for using components in the building of client and server applications is well known in the art. Further, these components may be linked together via various distributed programming protocols as distributed computing components.

### Distributed Computing Components and Protocols

Some example embodiments may include remote procedure calls being used to implement one or more of the above-illustrated components across a distributed programming environment. For example, a logic level may reside on a first computer system that is located remotely from a second computer system containing an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components contained therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

### A System of Transmission Between a Server and Client

Some embodiments may utilize the Open Systems Interconnection Basic Reference (OSI) model or Transmission Control Protocol/Internet Protocol (TCP/IP) protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, or some other suitable protocol. These networks may be organized within a variety of topologies (e.g., a star topology) or structures.

### A Computer System

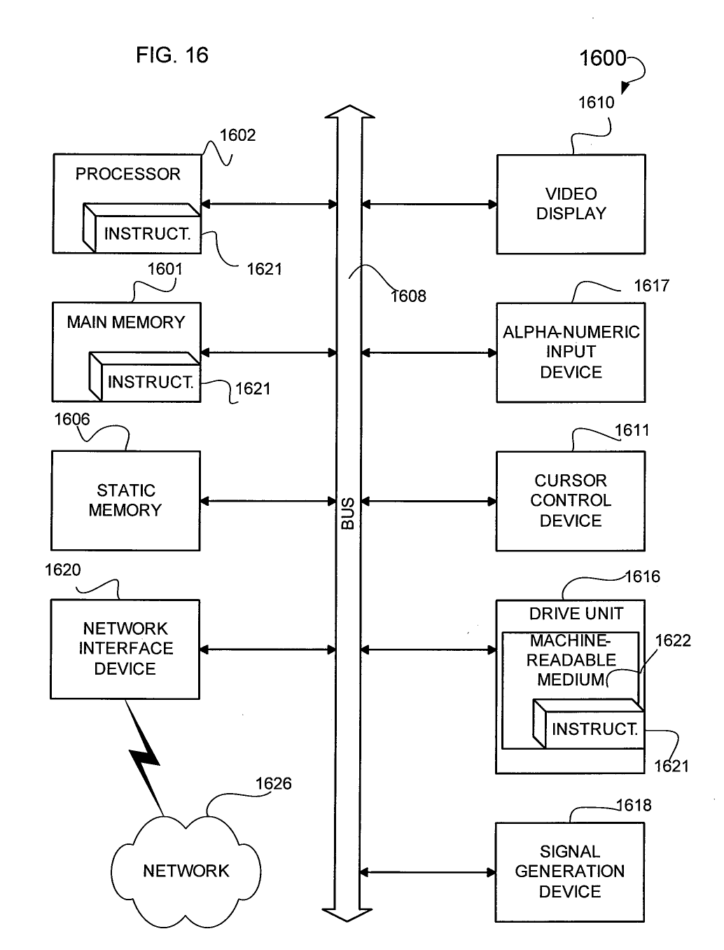

FIG. 16 shows a diagrammatic representation of a machine in the example form of a computer system 1600 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1600 includes a processor 1602 (e.g., a CPU, a Graphics Processing Unit (GPU) or both), a main memory 1601, and a static memory 1606, which communicate with each other via a bus 1608. The computer system 1600 may further include a video display unit 1610 (e.g., a Liquid Crystal Display (LCD) or a Cathode Ray Tube (CRT)). The computer system 1600 also includes an alphanumeric input device 1617 (e.g., a keyboard), a UI cursor controller 1611 (e.g., a mouse), a disk drive unit 1616, a signal generation device 1618 (e.g., a speaker) and a network interface device (e.g., a transmitter) 1620.

The disk drive unit 1616 includes a machine-readable medium 1622 on which is stored one or more sets of instructions and data structures (e.g., software) 1621 embodying or used by any one or more of the methodologies or functions illustrated herein. The software instructions 1621 may also reside, completely or at least partially, within the main memory 1601 and/or within the processor 1602 during execution thereof by the computer system 1600, the main memory 1601 and the processor 1602 also constituting machine-readable media.

The software instructions 1621 may further be transmitted or received over a network 1626 via the network interface device 1620 using any one of a number of well-known transfer protocols (e.g., HTTP, or Secure Hyper Text Transfer Protocol (HTTPS)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

### Marketplace Applications

In some example embodiments, a system and method is illustrated that allows for the distribution of portions of collaborative lists. These portions of collaborative lists may be distributed throughout a share structure on the basis of privileges. These privileges may be associated with members of the share structure. Where a privilege does not exist, data may not be distributed as part of the collaborative list.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving a collaborative list, the collaborative list including structured data and access privilege data, the access privilege data associated with a share structure, the share structure referencing one or more members;
selecting data from the structured data based on the access privilege data for a member from the one or more members referenced in the share structure;
displaying the selected data from the structured data in a first display area of a Graphical User Interface (GUI); and
displaying a representation of the share structure in a second display area of the GUI contemporaneously with the displaying of the selected data from the structured data.

2. The computer implemented method of claim 1, further comprising aggregating template data from a plurality of source templates to generate a template, the structured data displayed using the template.

3. The computer implemented method of claim 1, further comprising:
identifying an additional member, and additional privilege data associated with the additional member;
determining that, based upon the additional privilege data, the additional member is to be denied access to the collaborative list;
selectively receiving a portion of the collaborative list based on the determination, the portion of the collaborative list including a reduced amount of the structured data relative to the structured data as a whole; and
displaying the reduced amount of the structured data in the first display area of the GUI.

4. The computer implemented method of claim 1, wherein the structured data is structured as at least one of a list or a table.

5. The computer implemented method of claim 1, wherein the share structure is a tree.

6. The computer implemented method of claim 5, wherein the tree reflects the organization of a legal entity.

7. The computer implemented method of claim 1, further comprising:
retrieving at least one privilege associated with an additional member of the share structure; and
receiving selection input, through an input device, to set the at least one privilege associated with the additional member of the share structure.

8. The computer implemented method of claim 1, further comprising:
receiving selection input through an input device identifying an additional member of the share structure to access the collaborative list; and
enabling access by the additional member to the collaborative list based, in part, upon the existence of an additional access privilege associated with the additional member of the share structure.

9. The computer implemented method of claim 1, wherein the access privilege includes at least one of a distribute privilege, an edit privilege, or a read privilege.

10. The computer implemented method of claim 1, further comprising receiving selection input identifying the at least one member of the share structure, the identifying including the use of a graphical pointer.

11-13. (canceled)

14. A computer system comprising:
a receiver to receive, utilizing at least one processor, a collaborative list, the collaborative list including structured data and access privilege data, the access privilege data associated with a share structure, the share structure referencing one or more members;
a selection receiver to select data from the structured data based on the access privilege data for a member from the one or more members referenced in the share structure;
a display to display the selected data from the structured data in a first display area of a Graphical User Interface (GUI); and
an additional display to display a representation of the share structure in a second display area of the GUI contemporaneously with the displaying of the selected data from the structured data.

15. The computer system of claim 14, further comprising an aggregation engine to aggregate template data from a plurality of source templates to generate a template, the structured data displayed using the template.

16. The computer system of claim 14, further comprising:
the privilege identification engine to identify an additional member, and additional privilege data associated with the additional member;
a share engine to determine that, based upon the additional privilege data, the additional member is to be denied access to the collaborative list;
the selection receiver to selectively receive a portion of the collaborative list based on the determination, the portion of the collaborative list including a reduced amount of the structured data relative to the structured data as a whole; and
the display to display the reduced amount of the structured data in the first display area of the GUI.

17. The computer system of claim 14, wherein the structured data is structured as at least one of a list or a table.

18. The computer system of claim 14, wherein the share structure is a tree.

19. The computer system of claim 18, wherein the tree reflects the organization of a legal entity.

20. The computer system of claim 14, further comprising:
a privilege retriever to retrieve at least one privilege associated with an additional member of the share structure; and
an input receiver to receive selection input, through an input device, to set the at least one privilege associated with the additional member of the share structure.

21. The computer system of claim 14, further comprising:
an input receiver to receive selection input through an input device identifying an additional member of the share structure to access the collaborative list; and
an enablement engine to enable access by the additional member to the collaborative list based, in part, upon the existence of an additional access privilege associated with the additional member of the share structure.

22. The computer system of claim 14, wherein the access privilege includes at least one of a distribute privilege, an edit privilege, or a read privilege.

23. The computer system of claim 14, further comprising an input receiver to receive selection input identifying the at least one member of the share structure, the identifying including the use of a graphical pointer.

24-26. (canceled)

27. An apparatus comprising:
means for receiving a collaborative list, the collaborative list including structured data and access privilege data, the access privilege data associated with a share structure, the share structure referencing one or more members;
means for selecting data from the structured data based on the access privilege data for a member from the one or more members referenced in the share structure;
means for displaying the selected data from the structured data in a first display area of the GUI; and
means for displaying a representation of the share structure in a second display area of the GUI contemporaneously with the displaying of the selected data from the structured data.

28. A non-transitory machine-readable storage medium comprising instructions, which when implemented by one or more machines, cause the one or more machines to perform the following operations:
receiving a collaborative list, the collaborative list including structured data and access privilege data, the access privilege data associated with a share structure, the share structure referencing one or more members;
selecting data from the structured data based on the access privilege data for a member from the one or more members referenced in the share structure;
displaying the selected data from the structured data in a first display area of the GUI; and
displaying a representation of the share structure in a second display area of the GUI contemporaneously with the displaying of the selected data from the structured data.
